(19) United States
(12) Patent Application Publication
(10) Pub. No.: US 2023/0347300 A1
(43) Pub. Date: Nov. 2, 2023

(54) SINTERED POROUS BODY WITH MULTIPLE LAYERS

(71) Applicant: ENTEGRIS, INC., Billerica, MA (US)

(72) Inventors: Robert S. Zeller, Boston, MA (US); Virendra Warke, North Chelmsford, MA (US)

(21) Appl. No.: 18/141,113

(22) Filed: Apr. 28, 2023

Related U.S. Application Data
(60) Provisional application No. 63/336,683, filed on Apr. 29, 2022.

(51) Int. Cl. B01D 69/12; B01J 20/02; B01J 20/28; B01J 20/30; B01D 69/04; B01D 69/02; B01D 67/00; B01D 71/02; B01D 53/22

(52) U.S. Cl. CPC B01D 69/12; B01J 20/0225; B01J 20/28035; B01J 20/28007; B01J 20/3078; B01J 20/3035; B01D 69/1218; B01D 69/04; B01D 69/02; B01D 67/00411; B01D 71/02232; B01D 53/228; B01D 2325/022; B01D 2323/12; B01D 2325/20; B01D 2325/24; B01D 2256/22; B01D 2053/223

(57) ABSTRACT

Described are porous, sintered inorganic bodies that include multiple layers made from different types of metal particles, that may be useful as filter membranes, and also to methods of making and using the porous, sintered inorganic bodies.

### FIELD

The disclosure relates to porous, sintered inorganic bodies that include multiple layers made from different metal particles, that may be useful as filter membranes, and also to methods of making and using the porous, sintered inorganic bodies.

### BACKGROUND

Porous, sintered bodies are used in a variety of industrial applications, including applications in which a porous sintered body is used as a filter membrane to remove contaminants from fluids that are used in manufacturing. Many manufacturing processes require extremely pure fluids as raw materials or as processing fluids. For example, many different phases of semiconductor and microelectronic device manufacturing require the use of highly pure gases or liquids as raw materials, and highly pure processing fluids for steps such as cleaning, etching, drying and other surface or material preparation steps. To provide highly pure fluids during manufacturing, inorganic porous membranes are often used as filter elements to remove contaminants from fluids immediately before use of the fluid.

The fluid may be in the form of a gas, a liquid, or a supercritical fluid. Supercritical carbon dioxide has a variety of uses in industry, including for cleaning, drying, and for solvent extraction applications. Highly pure, supercritical carbon dioxide may be used in the electronics and semiconductor manufacturing industries, which require extremely high cleanliness and purity of materials. In one such application, supercritical carbon dioxide may be used to remove photoresist material from surfaces of semiconductor wafers as well as wafer drying. Commonly, a supply of supercritical carbon dioxide is filtered prior to use to remove particulate impurities at a low-nanoscale level, for example by being filtered to remove particles in a size range of 10 or 20 nanometers, or smaller.

Carbon dioxide (CO₂) exists as a supercritical fluid at temperatures and pressures above its critical temperature (31.10° C., 87.98° F., 304.25 K) and critical pressure (7.39 MPa, 72.9 atmosphere, 1,071 pounds per square inch, 73.9 bar). Typical operating conditions for processes of filtering supercritical carbon dioxide include a temperature of over 70, 90, or 100 degrees Celsius, and a pressure over 25, 30, 35, or 40 megapascals (MPa).

Equipment that is used to process supercritical carbon dioxide must function at temperatures and pressures required to maintain carbon dioxide in a supercritical state. These conditions are significantly more severe than conditions used for filtering many other types of industrial raw materials or process fluids. Many filtering steps of other fluids occur at ambient or only slightly elevated temperatures and at pressures that are approximately atmospheric pressure, slightly above atmospheric pressure, or well below atmospheric pressure. Developing new, useful, and improved methods and equipment for filtering supercritical fluids such as supercritical carbon dioxide can be particularly challenging, because equipment and components such as filter membranes must be stable and durable over a useful operating lifetime at relatively high pressures and temperatures.

### SUMMARY

The following description relates to novel and inventive porous sintered bodies, filter membranes, methods of preparing the porous sintered bodies, and methods of using the porous sintered bodies as filter membranes.

A porous sintered membrane includes two (at least) layers made from sintered inorganic particles: a first layer that is derived mostly or entirely from a combination of coarse particles and fine particles, and a second layer that is derived mostly or entirely from a combination of fine particles and nanoparticles. The first layer functions substantially as a structural base of support for the multi-layer membrane, and exhibits high flow properties and sufficient strength and structure to support the second layer. The second layer functions as a filtering layer and as a strengthening layer. The second layer contains fine particles and nanoparticles, which in combination form a second layer that is effective for filtering applications, while also contributing to the overall strength of the multi-layer membrane.

The described porous sintered bodies can be effective as filter membranes for filtering a variety of different fluids and over broad ranges of temperature and pressure. The fluid may be a gas, a liquid, or a fluid in a supercritical state. The pressure may be ambient, elevated, or reduced. And the temperature may be ambient, elevated, or reduced. As particular examples, certain currently preferred porous sintered bodies may be useful as filter membranes for filtering fluids at relatively high temperature and pressure conditions, as with methods of filtering a supercritical fluid such as supercritical carbon dioxide.

In one aspect, the disclosure relates to a porous membrane. The membrane includes a first layer that contains a combination of sintered inorganic particles that include coarse particles having a particle size of at least 10 microns and a coarse particle sintering point, and first fine particles having a particles size of at least 1 micron and a first fine particle sintering point below the coarse particle sintering point. The membrane also includes a second layer that includes a combination of sintered inorganic particles that include second fine particles having a particle size of at least 1 micron and a second fine particle sintering point below the coarse particle sintering point, and nanoparticles having a particle size below 1 micron and a nanoparticle sintering point above the first fine particle sintering point and above the second fine particle sintering point.

In another aspect, the disclosure relates to a method of forming a porous membrane. The method includes: preparing a precursor that includes a first blend of inorganic particles that include: coarse particles having a particle size of at least 10 microns and a coarse particle sintering point, and first fine particles having a particles size of at least 1 micron and a first fine particle sintering point below the coarse particle sintering point; applying a second blend of inorganic particles to a surface of the precursor, the second blend including second fine particles having a particle size of at least 1 micron and a second fine particle sintering point below the coarse particle sintering point, and nanoparticles having a particle size below 1 micron and a nanoparticle sintering point above the first fine particle sintering point and above the second fine particle sintering point.

In another aspect, the disclosure relates to a tubular porous membrane. The membrane includes: coarse particles having a particle size of at least 10 microns, fine particles having a particles size of at least 1 micron, and nanoparticles having a particle size below 1 micron. The membrane has: a bubble point of at least 30 pounds per square inch as measured by ASTM E 128-99 (2019), measured by using 60/40 isopropyl alcohol (IPA)/water; an air flux value of a least 0.07 slpm/cm2 at 30 psi; and a radial crush test value of at least 35 kilopounds per square inch measured using ASTM B939-21.

### BRIEF DESCRIPTION OF THE FIGURES

FIG. 1 is a schematic illustration showing a cut-away view of an example porous metal body as described. This schematic illustration is illustrative and not necessarily to scale.

FIG. 2 is a photomicrograph of an example porous metal body as described.

FIG. 3 shows an example of a filter assembly as described, that include a filter housing and a multi-layer porous sintered body.

### DETAILED DESCRIPTION

The following describes novel porous, sintered inorganic bodies (e.g., “porous bodies,” “porous sintered bodies,” or sometimes simply “membranes” or “bodies” herein) that can be useful as filter membranes for filtering a flow of a fluid to remove a small-scale, e.g., nanoscale, impurity from the fluid.

A porous sintered body as described is in the form of a porous, inorganic body that contains at two layers, each layer being made to include sintered inorganic particles. A first layer is derived mostly or entirely from a combination of coarse particles and fine particles. A second layer is derived mostly or entirely from a combination of fine particles and nanoparticles. Each layer is made of a matrix that contains the described inorganic particles, which have become interconnected at surfaces of the particles by a sintering step.

The first layer functions substantially as a structural base of support for the multi-layer membrane, and exhibits high flow properties and sufficient strength and structure to support the second layer. The second layer functions as a filtering layer and as a strengthening layer. To provide both strength and the filtering functions, the second layer contains two types of particles, fine particles and nanoparticles, that combine to form a second layer that performs the filtering functionality while also increasing strength of the multi-layer membrane. Fine particles in the second layer provide a porous structure within which the nanoparticles are contained and supported. The fine particles of the second layer provide structure and strength. The nanoparticles provide a filtering effect by providing a matrix that defines very small pores that are capable of removing small-scale contaminants (e.g., nano-scale contaminants) from fluid that passes through the second layer.

The porous sintered body is a porous inorganic structure that includes a matrix that is derived from and therefore is referred to as “including” (e.g., comprising, consisting of, or consisting essentially of) inorganic (e.g., metal, ceramic) particles that have been connected together (e.g., “interconnected”) at their surfaces by a step of sintering the particles. The particles are fused or bonded together at contacting surfaces to form the interconnected matrix by a step of sintering a precursor body that contains the different types of inorganic particles in an un-sintered, optionally compressed condition.

The term “sintering” as used herein has a meaning that is consistent with the meaning that this term is given when used in the arts of porous sintered structures, such as porous sintered inorganic membranes of the type that may be useful as a metal filter membrane. Consistent therewith, the term “sintering” can be used to refer to processes of bonding (e.g., “welding” or “fusing”) together a collection of small inorganic particles of one or more different types (sizes, compositions, shapes, etc.) by applying heat to a non-sintered body that includes the particles (e.g., a “precursor”), to cause the particles to reach a temperature that causes the particles to become fused together, i.e., welded together, by a material bond between surfaces of adjacent particles, but that does not cause the particles to melt, i.e., particles do not reach a melting temperature or become a flowable liquid.

As used herein, a “sintering point” or “sintering temperature” of a collection of inorganic particle is a temperature at which the particles are capable of being sintered, i.e., a temperature at which particles within a collection of particles with surfaces that contact one another can be fused together without melting, at a particular pressure such as at atmospheric pressure. A sintering point of inorganic particles is normally below a melting temperature of the particles, meaning the temperature at which the material of the particles becomes liquid. A sintering point of a collection of particles depends on factors that include the chemical makeup of the particles and the size and shape of the particles; smaller particles made of an inorganic material may have a lower sintering point compared to larger particles made of the same inorganic material.

A porous sintered body as described can be in the form of a porous, sintered, inorganic multi-layer membrane. Different layers of the multi-layer membrane contain different types of inorganic particles that function differently in terms of providing strength and filtering properties of the sintered membrane. An inner, or “first,” layer can function to provide significant strength to the sintered membrane and to provide strength to an un-sintered (green) form used to prepare the sintered porous membrane; the first layer is not required to exhibit filtering properties (by a sieving mechanism) for small-scale particles and may have pores of sizes that allow a relatively high level of fluid flow through the first layer, compared to a lower level of fluid flow through a second layer.

The outer, or “second” layer can add an additional amount of strength to the porous sintered membrane, and also contains small pores formed by the sintered nanoparticles, to function as a sieve-type filtering layer.

The different layers contain at least three different types of inorganic particles, referred to as “coarse” particles, “fine” particles, and “nanoparticles,” which may have different sizes, different compositions, different sintering points, or combinations of these. Examples of inorganic particles that are useful as any of the different types of particles of a first layer or a second layer of a sintered membrane include inorganic particles that may be metal or ceramic. Metal particles may contain (comprise, consist of, or consist essentially of) one or more metals, either as a pure metal or as an alloy. Example metals include iron, refractory metals (e.g., tungsten, molybdenum, tantalum), titanium, and nickel. Examples of metal alloys include stainless steel, another iron or steel alloy, nickel alloys, titanium alloys, among others. Example ceramics include metal oxides, e.g., zirconia (ZrO₂), alumina (Al₂O₃), etc. According to specific example membranes, fine particles can be made of the same material as coarse particles, e.g., fine particles of a membrane are made of a metal or metal alloy, such as stainless steel, nickel, or a nickel alloy, and the coarse particles of the same membrane are made of the same metal or metal alloy.

Particles referred to as “coarse” particles can be included in and can make up a major portion of a first membrane layer. The coarse particles provide strength to the first layer and to the sintered multi-layer membrane, and can result in a first layer that has relatively large pores that allow relatively high fluid flow through the first layer, but that do not perform a sieve-type filtering function with respect to small-scale (e.g., nano-scale) contaminants.

Coarse particles begin as a raw material in the form of a powder, meaning a collection of small (micron scale) particles typically having similar composition and a range of sizes. Coarse particles used to produce a first layer can have shapes and sizes that allow for the coarse particles to be useful in forming a first layer as described, based on methods as described, that will be effective for the particles to form a first layer of a porous sintered body upon sintering.

Example coarse particles may have particles sizes in a range of tens of microns, e.g., from 10 to 200 microns, 10 to 150 microns, 10 to 100 microns, 25 to 200 microns, 25 to 150 microns, 25 to 100 microns, 25 to 75 microns, 50 to 200 microns, 50 to 150 microns, or any ranges or subranges therebetween. Particle size of metal and ceramic particles can be measured by ASTM B822-17 (Standard Test Method for Particle Size Distribution of Metal Powders and Related Compounds by Light Scattering).

The coarse particles can include shapes or surfaces that may be regular (e.g., consistent within a powder) or irregular, e.g., a shape that is round or spherical, globular, branched, etc. Examples of useful coarse particles can be generally round, non-high-aspect ratio particles within a multi-micron size range. The particles are typically rounded, non-dendritic, and do not exhibit a high aspect ratio, e.g., exhibit an aspect ratio below 10, below 5, or below 4 or 3 on average.

Example coarse particles used to form a first layer can be made substantially of or entirely of (may comprise, consist of, or consist essentially of) ceramic, metal or a metal alloy, e.g., a refractory metal, stainless steel, nickel, a nickel alloy, e.g., may contain at least 90, 95, 98, or 99 percent by weight ceramic, metal (pure metal) or a metal alloy, such as stainless steel, nickel, or nickel alloy. Coarse particles that contain a high amount of stainless steel may have a sintering point in a range from 900 to 1200 degrees Celsius. Coarse particles that contain a high amount of nickel or nickel alloy may have a sintering point in a range from 1000 to 1300 degrees Celsius. Coarse particles that contain a high amount of ceramic or refractory metal (e.g., at least 90, 95, 98, or 99 percent by weight ceramic or refractory metal) may have a sintering point that is greater than 1300 or 1400 degrees Celsius.

As used herein, a material or combination of materials that is said to “consist essentially of” a material or combination of materials will contain the material or combination of materials and not more than an insubstantial amount of other materials, e.g., not more than 1, 0.5, or 0.1 weight percent of any other ingredient; e.g., coarse particles that consist essentially of nickel are made of nickel and not more than 1, 0.5, or 0.1 weight percent of any other ingredient.

Particles referred to as “fine” particles can be included in and can make up a major portion of the first layer as well as major portion of the second layer. Fine particles are smaller than coarse particles and larger than nanoparticles, e.g., may have a particle size greater than 1 micron but less than 10 microns. Fine particles can function to provide strength, continuity, and integrity of the multi-layer sintered membrane by being present in both the first layer and the second layer, thereby providing a continuous sintered network that produces continuity and strength between the two layers.

In certain example membranes, the fine particles may have a chemical makeup that is the same as the chemical makeup of the coarse particles, to facilitate sintering of the differently-sized coarse and fine particles in the first layer. The sintering point of the fine particles may be at a temperature that is below a sintering point of the coarse particles and below a sintering point of the nanoparticles. In certain example membranes, the fine particles may have a chemical makeup that is different from the chemical makeup of the nanoparticles, to allow the fine particles to have a sintering point that is below the sintering point of the nanoparticles.

Fine particles that are included in the first layer (“first fine particles”) may be the same as or different from fine particles of the second layer (“second fine particles”) with respect to particle size and particle makeup. In example membranes, the first fine particles can have the same chemical makeup and the same size and shape (average size, size profile, shape and morphology (e.g., dendritic)) as the second fine particles.

Example fine particles (first fine particles and second fine particles) can be in the form of a powder that contains a collection of particles made substantially of or entirely of (may comprise, consist of, or consist essentially of) ceramic, metal (e.g., refractory metal, nickel), or a metal alloy such as stainless steel, or a nickel alloy, e.g., may contain at least 90, 95, 98, or 99 percent by weight ceramic, refractory metal, stainless steel, nickel, or nickel alloy. Fine particles that contain a high amount of stainless steel may have a sintering point in a range from 900 to 1200 degrees Celsius, with fine particles contained in any particular sintered membrane having a sintering point that is below the sintering point of coarse particles in the membrane. Fine particles that contain a high amount of nickel or nickel alloy may have a sintering point in a range from 600 to 1100 degrees Celsius, with fine particles used in a particular sintered membrane having a sintering point that is below the sintering point of coarse particles in the membrane. Fine particles that contain a high amount of ceramic or refractory metal (e.g., at least 90, 95, 98, or 99 percent by weight ceramic or refractory metal) may have a sintering point that is greater than 1300 or 1400 degrees Celsius.

Fine particles can be formed to have shapes or surfaces that may be regular (e.g., consistent within a powder) or irregular, e.g., shapes that are round or spherical, globular, branched, elongate, dendritic, etc. In particular examples, first fine particles and second fine particles may be of the type sometimes referred to as highly anisotropic dendritic particles, such as those described in U.S. Pat. No. 5,814,272 (“the '272 patent”), the entirety of which is incorporated herein by reference.

According to the '272 patent, and as used herein, the term “dendritic” refers to a highly anisotropic, irregular particle morphology wherein particles have a structure that includes one or typically multiple filaments or branches, each filament or branch individually having one dimension (out of three dimensions) that is greater than the other two dimensions of the filament. The one or more branches or filaments may independently be straight or bent, and may be branched or unbranched. Dendritic particles are characterized by low packing efficiencies compared to particles of more regular morphology and, therefore, form powders of lower apparent density compared to powders formed by particles that are made with the same chemical composition but have a more regular (non-dendritic) morphology. Under magnification, dendritic particles can appear as aggregates or agglomerates of non-dendritic starting particles. See FIG. 6 of the '272 patent.

Dendritic powders can be effective to form self-supporting precursor bodies (e.g., green forms, see infra) and sintered bodies of relatively lower density and higher porosity compared to precursor bodies and sintered bodies made of comparable non-dendritic powders.

Dendritic particles may be formed by fusing together non-dendritic particles or partially-dendritic particles that are part of a collection of particles in a powder. In brief, powders of dendritic particles can be formed by methods described in the '272 patent. Accordingly, a powder of dendritic particles may be formed from a substantially a powder of non-dendritic particles by heating the non-dendritic powder under conditions that are suitable for initial stage sintering, to form a lightly-sintered material. The lightly-sintered material can then be processed to break apart some of the sintered and bonded particles, to form dendritic particles. These steps may be repeated if desired.

The term “lightly sintered material” refers to a material created by the fusion of metal powder particles through an initial stage of sintering, as defined by Randall (Randall in “Powder Metallurgy Science”, second edition, German, ed., Metal Powder Federation Industry (1994), the contents of which are incorporated herein by reference). In an initial stage of sintering, or short-range diffusional sintering, bonds form between particles at the particles' contacting surfaces, resulting in the fusion of metal powder particles with their immediate neighbors only. Thus, the initial stage of sintering yields a brittle structure of low mechanical strength. For a given material, sintering proceeds slowly beyond this initial stage at temperatures at the lower end of the material's sintering range. For the purposes of the present description the term “initial stage sintering” refers to the sintering of a powder under conditions in which sintering does not proceed substantially beyond the initial stage.

The term “substantially non-dendritic particles” refers to particles, e.g., in the form of a powder or as part of a green body or a sintered membrane, that contain mostly or entirely (e.g., at least 80, 90, or 95 percent by weight) particles that have a non-dendritic morphology

Particles referred to as “nanoparticles” can be included in and can make up a major portion of the second layer to produce a second layer that has pores that are sufficiently small to remove very small-scale (nanoscale) contaminants from a fluid by a sieving filtration mechanism. The nanoparticles are much smaller than the coarse particles and are smaller than the fine particles, e.g., nanoparticles may have sub-micron particles sizes, e.g., below 1.0 or 0.9 micron, such as in a range from 0.001 to 0.5 micron.

In certain example membranes, nanoparticles may have a chemical makeup that is different from the chemical makeup of the coarse particles and is also different from the chemical makeup of the fine particles. The nanoparticles may also have a sintering point that is higher than a sintering point of the fine particles (both first fine particles and second fine particles). The sintering point of the nanoparticles may be higher than the sintering point of the coarse particles, lower than the sintering point of the coarse particles, or approximately the same as the sintering point of the coarse particles.

The use of nano-scale inorganic particles in a second layer of a sintered membrane can produce a sintered membrane that can exhibit a pore size (e.g., as indicated by bubble point) in a nanometer range, e.g., below 50, 20, or 10 nanometers. With a nano-scale pore size, the sintered membrane can be effective to remove nano-scale particle contaminants from a fluid by a sieving mechanism, by the filter having pores that are smaller than the size of contaminants.

Example nanoparticles of a sintered membrane or a precursor can be made substantially of or entirely of (may comprise, consist of, or consist essentially of) stainless steel, titanium or a titanium alloy, a refractory metal, a ceramic such as zirconia (ZrO₂) or alumina (Al₂O₃), e.g., may contain at least 90, 95, 98, or 99 percent by weight stainless steel, titanium, titanium alloy, or ceramic. Nanoparticles that include a high amount of stainless steel may have a sintering point in a range from 800 to 1100 degrees Celsius, with nanoparticles used in any particular sintered membrane having a sintering point that is greater than a sintering point of first fine particles and second fine particles of the sintered membrane. Nanoparticles that contain a high amount of titanium, titanium alloy, or ceramic may have a sintering point in a range from 1000 to 1400 degrees Celsius, with nanoparticles used in a particular sintered membrane having a sintering point that is above the sintering point of first fine particles and second fine particles in the sintered membrane. Nanoparticles that contain a high amount of ceramic or refractory metal (e.g., at least 90, 95, 98, or 99 percent by weight ceramic or refractory metal) may have a sintering point that is greater than 1300 or 1400 degrees Celsius.

The shapes of nanoparticles can include shapes or surfaces that may be regular (e.g., consistent within a powder) or irregular, such as round or spherical, globular, branched, etc., and may be non-dendritic.

The sintered membrane, contains the three different types of particles (coarse, fine, nanoparticles), includes two visually distinct but physically inter-connected layers that when present together in a multi-layer membrane provide a membrane that has very fine pore size for filtering very fine particles, while also having high strength. The different sizes, chemical makeups, and sintering points of the coarse particles, fine particles, and nanoparticles are selected to produce a desired combination of filtering effectiveness, strength properties, and processing (sintering) properties.

The first membrane layer includes fine particles (first fine particles) and coarse particles, with the chemical makeups of the fine and coarse particles preferably being similar or identical. Selecting fine particles and coarse particles to have similar or identical chemical makeups can improve the ability of the particles to become bonded by sintering. The fine particles of the first layer (first fine particles) can also have a similar or identical chemical makeup as fine particles of the second layer, to provide strength and physical continuity between the first layer and the second layer. In example membranes, the first layer does not require nanoparticles and preferably does not contain nanoparticles, e.g., contains less than 1, 0.5 or 0.1 weight percent nanoparticles.

The second layer includes second fine particles in combination with smaller “nanoparticles,” without the need for any coarse particles. The second fine particles can have similar or identical chemical makeup as the first fine particles, to provide strength and continuity between the first layer and the second layer. The nanoparticles can have a different chemical makeup (chemical composition) compared to the first fine particles, compared to the second fine particles, and compared to the coarse particles.

The fine particles and the nanoparticles of the second layer provide a combination of useful functions for the second layer. The nanoparticles, when sintered, define a desirably small pore size for filtering nano-scale particles by a sieving filtration mechanism. The fine particles, especially if these are the same (size, chemical makeup) as the fine particles of the first layer, provide desired processing, strength, and stability properties because the fine particles of both the first and second layers will experience similar levels of sintering, which can result in a physical connection between the first membrane layer and the second membrane layer.

The nanoparticles also have a higher sintering point compared to the first fine particles and the second fine particles, and may optionally have a sintering point that is higher than the sintering point of the coarse particles. During processing (sintering), the nanoscale particles may experience only initial stage sintering while the other particles will sinter more fully. Desirably, the nanoparticles do not experience any melting during sintering. Melting or excessive sintering may cause cracking or distortion of the second membrane layer, poor flow through the sintered membrane, and a reduced bubble point.

Selecting nanoparticles that have a higher sintering point compared to the first and second fine particles, and optionally a higher sintering point compared to the coarse particles, can cause a desirable relatively reduced degree of sintering of the nanoparticles compared to a higher degree of sintering of the fine particles and the coarse particles. The lower degree of sintering of the nanoparticles allows for increased control of filtering and flow properties of the sintered membrane, e.g., increased control of fluid flow as measured by pressure drop, and pore size as measured by bubble point. Adjusting the relative amount of the nanoparticles in the second layer of the membrane and in the total multi-layer membrane can be useful to achieve desired flow properties, pore size (for filtering), bubble point, etc.

The different layers may contain ranges of useful amounts of the different types of particles. A first layer may contain effective relative amounts of the coarse particles and the fine particles In certain examples, a first layer can include (comprise, consist of, or consist essentially of) from 50 to 70 weight percent coarse particles and from 30 to 50 weight percent fine metal particles.

The second layer may contain any effective relative amounts of fine particles and nanoparticles particles. In certain examples, a second layer can include (comprise, consist of, or consist essentially of) from 40 to 75 weight percent fine particles and from 25 to 60 weight percent nanoparticles.

A sintered membrane may contain any useful relative amounts of the first layer and the second layer. In certain examples, a sintered membrane may include (comprise, consist of, or consist essentially of) from 50 to 75 weight percent first layer and from 25 to 50 weight percent second layer, based on total weight sintered membrane.

The total membrane thickness, and the relative thicknesses of the first and second layers of a membrane may be selected as desired. A first layer may have a thickness that will provide a support for the second layer without unduly restricting fluid flow through the body. The second layer may have a thickness that provides desired filtering performance and that may also contribute to overall strength of a membrane, especially a tubular membrane.

A total thickness of a porous sintered body for use as a filter membrane can be relatively thin, e.g., have a thickness that is relatively small in magnitude. A relatively more thin filter membrane can result in certain desired properties of a filter membrane including reduced mass and a reduced pressure drop across the filter during use. Examples of useful or preferred porous sintered membranes adapted for use as a filter membrane, e.g., in a tubular form and useful for filtering a supercritical fluid, can have a thickness that is below 1.5 or 2 millimeters, e.g., below 1, 0.9, or 0.8 millimeters, e.g., in a range from 0.4 to 1 millimeter.

In examples porous sintered membranes a first (coarse) layer may be either thicker or thinner than a second layer. According to certain examples, a membrane as described can have a first (coarse) layer thickness that is at least 50 percent of a total thickness of the body, e.g., at least 55, 60, 70, or 80 percent of the total thickness of the body. The second layer can have a thickness that is up to (i.e., not more than) 50 percent of a total thickness of the body, such as up to 20, 30, 40, 45, or 50 percent of a total thickness of the body.

The porous sintered membrane contains the first layer, the second layer, and may also contain but does not require other layers or materials. According to certain examples, a porous sintered body may be made to consist of or to consist essentially of only the first and second layers. A porous sintered body that “consists essentially of” the first layer and the second layer contains these two layers and not more than an insignificant amount of any other layer or material, e.g., not more than 1, 0.5, or 0.1 weight percent of any other layer or material.

A porous sintered membrane as described, as well as precursors thereof, include two (or more) identifiable portions or “layers” made from different types of particles. Without limiting the function of the different layers, a “first” layer is sometimes referred to herein as a “coarse layer” or a “support layer,” and a “second” layer is sometimes referred to as a “fine layer” or a “filtering layer.” The first layer is made with and includes a combination or “blend” of coarse particles and first fine particles, with no nanoparticles or substantially no nanoparticles. The second layer is made with and includes a combination or “blend” of second fine particles and nanoparticles, with no coarse particles or substantially no coarse particles.

The two different layers may be detected visually, using magnification. In the form of a sintered membrane, the first layer, which includes coarse particles and fine particles, will be viewable as containing a combination of the coarse particles bonded together at particle surfaces by a sintering step, with fine particles bonded to the coarse particles and to other fine particles. The first layer will have a relatively high porosity compared to the second layer, and will not contain a substantial amount of nanoparticles.

The second layer of a sintered membrane, which includes second fine particles and nanoparticles, will be viewable as containing a combination of fine particles and nanoparticles bonded together at particle surfaces by a sintering step. The second layer will have a relatively low porosity compared to the first layer and will not contain a substantial amount of coarse particles.

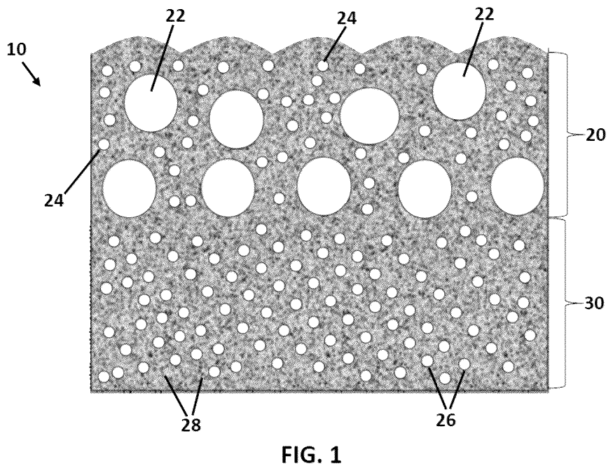

FIG. 1 schematically shows a side, cut-away view of a portion of a porous sintered membrane as described. Membrane 10 includes first layer 20 made mostly or entirely of coarse particles 22 and first fine particles 24. Membrane 10 also includes second layer 30 made mostly or entirely of second fine particles 26 and nanoparticles 28. The particles when formed into porous sintered membrane 10 are interconnected at surfaces of the sintered particles.

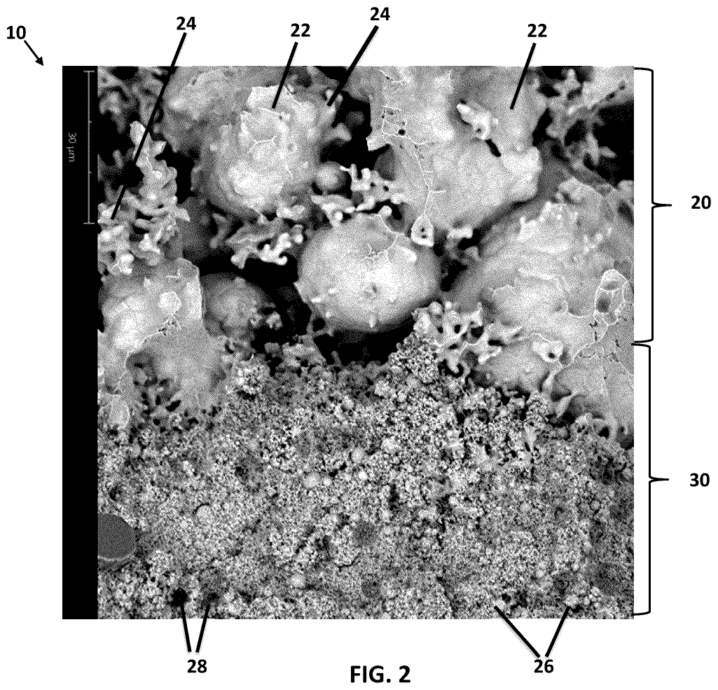

FIG. 2 is a photomicrograph image of a porous sintered membrane that is shown schematically at FIG. 1. Pictured are body membrane 10, first layer 20 made mostly or entirely of coarse particles 22 and first fine particles 24, and second layer 30 made mostly or entirely of second fine particles 26 and nanoparticles 28. The particles when formed into porous sintered membrane 10 are interconnected at surfaces of the sintered particles.

Exemplary porous sintered bodies can be assembled and formed into a sintered membrane of any useful size and configuration, e.g., as a flat sheet, or alternately as a three-dimensional shape such as in the form of a rounded cup, a cone, an open tube (open at two opposed ends), or closed-end tube (a.k.a. “closed cylinder,” meaning a tube or cylinder having one closed end and one open end). A particular example of a filter body useful for filtering supercritical carbon dioxide can be an open cylinder filter membrane, i.e., a tube, having a length in a range from 10 to 100 millimeters, and a diameter in a range from 0.5 to 2 inches, such as in a range from 0.75 to 1.5 inches.

A porous sintered membrane, and each layer thereof, can have properties that allow the membrane to be useful as a filtering membrane. Properties include porosity, bubble point (which is indicate of pore size), air flow, and strength (for a tubular filter membrane, strength can be measured using a radial crush test).

A first layer and a second layer the membrane as described may have porosity values that will allow the layers, in combination, to be effective for a desired use, e.g., as a filter membrane. According to useful examples, a first layer of a porous sintered body as described may have a porosity of at least 40 percent, e.g., a porosity in a range from 35 to 60 percent. A second layer of a porous sintered membrane can have a porosity in a range from about 15 to about 30 percent.

As used herein, and in the art of porous sintered bodies, a “porosity” of a porous sintered body (also sometimes referred to as void fraction) is a measure of the void (i.e. “empty”) space in the body as a percent of the total volume of the body, and is calculated as a fraction of the volume of voids of the body over the total volume of the body. A body that has zero percent porosity is completely solid.

A sintered membrane of the description can have a bubble point that is useful to allow the body to be effective in filtering a fluid, for example a supercritical fluid such as supercritical carbon dioxide. Examples of useful or preferred bubble points of a membrane can be at least 25, 30, 40, or 45 pound per square inch (psi), measured by bubble point test method ASTM E128-99 (2019), using a 60/40 mixture (by volume) of isopropyl alcohol (IPA) and water.

A sintered membrane of the description, having a tubular shape, can have a strength to withstand a pressure of at least 20, 25, 30, 35, 40, or 45 kilopounds per square inch (ksi) as measured by a radial crush test (ASTM B939-21).

A sintered membrane of the description, having a tubular shape, can have an “air flux” of at least 0.03, 0.04, 0.05, 0.06, 0.07, or 0.08 standard liter per minute (slpm) per square centimeter measured at 30 pounds per square inch pressure.

A porous body as described, prepared and used as a filter membrane, e.g., for filtering supercritical carbon dioxide, will exhibit filtering properties and flow properties that are comparable to or improved relative to previous porous sintered filter membranes. Filter membranes as described, particularly tubular filter membranes, can exhibit a useful combination of air flow, bubble point, and strength, or may exhibit an improved combination of two or more of these compared to porous sintered filter membranes that do not include the two specific layers described herein, made from the specified three types of inorganic particles.

Without being bound by theory, the different types of particles of the first and second layers are effective to provide a useful or even an advantageous combination of strength, air flow, and filtering properties (e.g., small pore size, desired bubble point, and strength). The coarse particles of the first membrane layer are effective to provide a high degree of strength in the sintered membrane; the nanoparticles in the second layer are effective to provide effective filtering (small pore size, relatively high bubble point); and the fine particles present in both the first layer and the second layer provide added strength and integrity by providing a sintered network of particles that connects the first layer with the second layer.

A porous sintered body as described can be used as a filter membrane to remove particle contamination having particle sizes in a nanometer scale, from a flow of fluid directed through the filter membrane. The fluid may be any type of fluid, including a gas, a liquid, or a supercritical fluid. The fluid may be any fluid that requires filtering to remove nano-scale particle contamination, including as a particular example supercritical carbon dioxide that contains particulate impurities at a low level, from any source.

Supercritical carbon dioxide is useful for processing or fabricating semiconductor and microelectronic devices. The porous sintered membrane may be effective to remove particulate contaminants from a fluid stream by a sieving or a non-sieving filtration mechanism, or both. Advantageously, a filter membrane that contains sintered nanoparticles as described, e.g., as part of a second layer, can include pores formed between the sintered nanoparticles that are sufficiently small to allow the membrane to remove nano-scale particles by a sieving mechanism, e.g., to remove contaminant particles that have a particles size of less than 50, 20, 10 nanometers by physically preventing the particles from passing through pores of the membrane that are smaller than the size of the contaminant particles.

The pressure of a fluid that is handled by a filtering system that includes a sintered membrane as described can be a relatively low pressure or a relatively high pressure. For methods and equipment used to filter certain types of fluids, including supercritical carbon dioxide, the pressure of a fluid within a filtering system, e.g., as the fluid passes through a filter membrane, is relatively high, such as at least 10, 20, or up to or in excess of 30 megapascal (MPa).

A pressure differential (or “pressure drop”) across a thickness of a filter membrane as described (between an upstream side of the filter and a downstream side of the filter), during use of the filter membrane, can be any pressure differential that allows for desired effectiveness (e.g., particle retention) during the filtering step (e.g., of a given flow rate of fluid), and that is also commercially feasible. For use of a sintered membrane as described, to filter supercritical carbon dioxide at elevated pressure, a differential across the filter membrane can be at least 1, 2, or 3 megapascal (MPa).

The amount of a fluid that flows through a filter membrane (volume through the filter per time) during a filtering step can be an amount that allows for desired effectiveness (e.g., particle retention) during the filtering step, and that is also commercially feasible.

The temperature of a flow of fluid through a filter membrane as described can be any temperature that allows for commercially effective filtering. For filtering supercritical carbon dioxide, a temperature may be relatively high, such as a temperature of at least 100, 150, or 200 degrees Celsius.

A sintered membrane as described can be prepared by a multi-step process of forming a precursor that contains a first layer of a combination of particles as descried, and a second layer of a combination of particles as described, followed by sintering the precursor to cause the particles of the layers to bond together to form a porous sintered membrane.

In certain example methods, a precursor can be formed by dry methods that use dry powders of metal particle without the need for any polymer or other liquid component being present within the powder. A first layer of a precursor can be formed by molding the first layer from a first dry powder that includes (comprises, consists of, or consists essentially of) a blend of coarse particles and fine particles, to form a first layer green body, e.g., using an isotactic molding technique. After a first layer green body is formed, a dry powder that contains (comprises, consists of, or consists essentially of) a blend of fine particles and nanoparticles as described for a second layer is applied uniformly to a surface of the first layer green body and compressed against the surface, again by an isotactic molding technique. The resultant green body, having a first (coarse) layer and a second (fine) layer, is then sintered to produce a sintered porous body having a first and a second layer as described herein. The green body and each of its two separate layers consist of or consist essentially of the layers produced from the powders, and does not require and may not include any other material such as a polymer (binder), surfactant, solvent, or the like.

According to one example step, a collection of particles in the form of a dry powder that includes mostly or entirely (consists of or consists essentially of) a blend of coarse particles and fine particles (first fine particles) is molded under pressure to compress the particles to form a thin membrane, e.g., in the form of a small tube. By one technique, the molding step can be of a type referred to as isotactic molding, or isotactic wet pressure molding. (See, e.g., U.S. Pat. No. 7,534,287, the entirety of which is incorporated herein by reference.) The membrane that is produced, which contains mostly or entirely a blend of coarse particles and the fine particles compressed together by the molding step, will become a first layer of a porous sintered body. The thin membrane is held together by the contact produced between the particles by the compression of the particles. The thin membrane, referred to as a “precursor” or a “green body,” which specifically here is a “first layer precursor,” is self-supporting yet fragile.

A second blend of particles contains mostly or entirely (consists of or consists essentially of) a blend of the fine particles (the “second” fine particles) and nanoparticles. This blend of particles is applied to one surface of the first layer precursor, e.g., is applied to an outer surface of a first layer precursor that is in the form of a tube. The second blend is applied in a manner to place a uniform and even amount of the blend over the surface of the first layer precursor. Effective methods of applying the blended particles to the surface of the first layer precursor are known and include methods referred to as “air laying” techniques, such as by placing a screen or mesh over the surface of the first layer, then passing the blend of particles through the screen, optionally with the use of a brush for evenly distributing the particles.

After evenly placing the second blend of particles over the surface of the first layer, the resultant body is again molded under pressure to compress the particles of the second blend to form the second layer compressed onto the surface of the first layer. Molding and compressing the second blend of particles onto the surface of the first layer can be performed by an isotactic molding technique, e.g., an isotactic wet pressure molding technique. The resulting precursor (“green body”) contains the compressed and non-sintered first layer made from the blend of coarse particles and first fine particles, and the compressed and sintered second layer made from the second blend that contains fine particles and nanoparticles.

In a subsequent step, the precursor is sintered at a sintering temperature that will be effective to bond the particles of both layers into a single porous sintered body. During sintering, the fine particles begin sintering first, before the coarse particles begin sintering and before the nanoparticles begin sintering. The first fine particles of the first layer and the second fine particles of the second layer will preferably experience similar levels of sintering during the sintering step, which can result in stability of the sintered membrane and can prevent cracking and distortion of the membrane.

The nanoparticles and the coarse particles will begin sintering at temperatures (sintering points) that are above the sintering point of the first fine particles and the sintering point of the second fine particles (these sintering points may be the same). The nanoparticles may optionally begin sintering point before (at a lower temperature) or after (at a higher temperature) the coarse particles begin sintering. During sintering the nanoscale particles can, preferably, experience only initial stage sintering while the other particles will sinter more fully. Desirably, the nanoparticles do not experience any melting during sintering.

A porous sintered membrane may be included in a filtering system or apparatus that includes a filter housing that contains and supports the filter membrane at a location of a fluid flow, to cause the fluid to flow through the membrane when the fluid passes through the filter housing. The filter housing can have an inlet, an outlet, and an internal volume that contains the filter membrane.

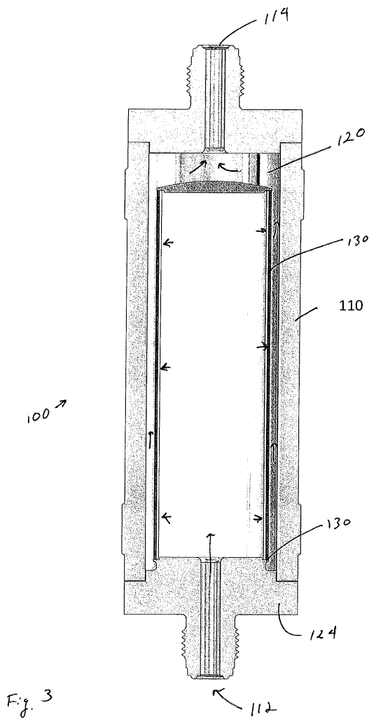

An example of a filter housing (in cross-section) is shown at FIG. 3. Example filter housing 100 includes housing body 110, fluid inlet 112, fluid outlet 114, and interior 120. Tubular multi-layer porous sintered body 130 is contained at interior 120, for example by being welded to housing base 124 at weld 130. In use, fluid (not shown) flows as indicated by the arrows into inlet 112, through filter membrane 130, through interior 120, and exits the filter housing through outlet 114.

Example tubular filter membranes as described are able to withstand a differential pressure used in a supercritical carbon dioxide filtering process without being ruptured, distorted, or otherwise physically compromised for a useful product lifetime. One method of determining the strength of a porous sintered tubular filter membrane is by what is referred to as a radial crush test, performed according to ASTM B939-21. By this test, a multi-layer sintered membrane in the form of a tubular membrane, having two layers made from sintered particles as described herein, can withstand at least 25, 30, 35, 40, or 45 kilopounds per square inch (ksi) when tested using the radial crush test.

### EXAMPLES

### Example 1—Method of Preparing a Sintered Membrane

A multi-layer porous sintered membrane is prepared by multiple steps, including the following. A first step is to prepare a first (inner) non-sintered membrane layer (a first layer green form), followed by a second step of preparing a second (outer) non-sintered layer on the outer surface of the first non-sintered layer. The two-layer precursor is then sintered to form a sintered, monolithic, inorganic (e.g., metallic), bi-layer, composite, asymmetric nanoporous tubular sieving membrane.

The first layer is a blend of 1-5 micron (“fine”), dendritic particles and 50-75 micron (“coarse”) particles of the same chemical composition in proportions of roughly fifty-percent of each type of particle by mass. A rubber tubular isostatic mold with a central steel mandrel is filled with the blend of the two particles and pressed at a pressure sufficient to form a cohesive green form.

The second layer is made from a blend of particles that includes 1-5 micron (“fine’), non-dendritic particles and 30-150 nanometer (“nanoparticles), with the nanoparticles being of a different chemical composition than the fine particles. The two different particles are combined to form a blend that contains approximately 50 percent by weight of each of the two different types of particles. The blend is dispensed into a rubber isostatic tubular mold with the green form from the previous step serving as the central mandrel and pressed at a pressure to form a cohesive green form and further to define the tightness (pore size) of the porous matrix being constructed.

The resulting bi-layer green form precursor is sintered in an appropriate atmosphere (one that is compatible with the materials used) with heat input to sinter all materials to adjacent materials and to themselves, but not enough to over-sinter or melt the pore-defining nanoparticles.

### Example 2—Sintered Membrane Performance

| | | ASTM E128-99 (2019) | ASTM B939-21 Radial | Flow/unit area at |
|---|---|---|---|---|
| # | Membrane | Bubble point (60/40 IPA)-psi | Crush Test-KSI | 30 psi-splm/cm\hat{ }2 |
| 1 | present disclosure* | 45 | 35 | 0.08 |
| A | U.S. Pat. No. 7,534,287 | 13 | 24 | 0.65 |
| B | U.S. Pat. No. 7,534,287 | 26 | 50 | 0.07 |

*using: As a first layer, a blend of 50/50 by mass fine particles and coarse particles; and
As a second layer, a blend of 50/50 by mass nano particles and fine particles

Example membranes prepared according to the disclosure may exhibit a relatively high bubble point (reduction in pore size) compared to existing commercially available products, while maintaining or exceeding strength as measured by Radial Crush Test, or flux (flow/area) of tubular designs.

Examples A and B are tubular inorganic porous membranes that were prepared based on the description of U.S. Pat. No. 7,534,287. Examples A and B were prepared from nickel particles that include fine dendritic particles and nanoparticles, but no coarse particles (as that term is used herein) The Example A and Example B membranes included an inner layer prepared from only the fine dendritic nickel particles, and an outer layer prepared from a blend of the fine dendritic nickel particles and nickel nanoparticles.

While the Example 1 (present disclosure) membrane has lower strength compared to the Example B membrane, Example 1 exceeds in both flux and bubble point. Likewise, the flux of the Example 1 membrane is lower than the flux of Example A, but the Example 1 membrane exceeds in strength and bubble point. As can be seen in the table above, a porous membrane as disclosed herein can achieve a combination of bubble point of at least 30 psi, an air flux of at least 0.07 slpm/cm2 at 30 psi, and a radial crush test value of at least 35 kilopounds per square inch.

A first aspect a porous membrane comprises a first layer comprising a combination of sintered inorganic particles comprising: coarse particles having a particle size of at least 10 microns and a coarse particle sintering point, and first fine particles having a particles size of at least 1 micron and a first fine particle sintering point below the coarse particle sintering point, a second layer comprising a combination of sintered inorganic particles comprising: second fine particles having a particle size of at least 1 micron and a second fine particle sintering point below the coarse particle sintering point, and nanoparticles having a particle size below 1 micron and a nanoparticle sintering point above the first fine particle sintering point and above the second fine particle sintering point.

In a second aspect according to the first aspect, the coarse particles have a particle size in a range from 10 to 200 microns.

In a third aspect according to the previous aspects, the first fine particles have a particle size in a range from 1 to 10 microns, and the second fine particles have a particle size in a range from 1 to 10 microns.

In a fourth aspect according to the previous aspects, the nanoparticles have a size in a range from 0.001 to 0.5 micron.

In a fifth aspect according to the previous aspects, the first fine particles comprise nickel or a nickel alloy, the second fine particles comprise nickel or a nickel alloy, the coarse particles comprise nickel or a nickel alloy, and the nanoparticles comprise stainless steel.

In a sixth aspect according to the fifth aspect, the first fine particle sintering point is in a range 600 to 1100 degrees Celsius, the second fine particle sintering point is in a range 600 to 1100 degrees Celsius, the coarse particle sintering point is in a range from 900 to 1200 degrees Celsius, and the nanoparticle sintering point is in a range 800 to 1100 degrees Celsius.

In a seventh aspect according to any of the first through fourth aspects, the first fine particles comprise stainless steel, the second fine particles comprise stainless steel, the coarse particles comprise stainless steel, and the nanoparticles comprise titanium, titanium alloy, alumina, or zirconia (ZrO₂).

In an eighth aspect according to the seventh aspect, the first fine particle sintering point is in a range 900 to 1200 degrees Celsius, the second fine particle sintering point is in a range 900 to 1200 degrees Celsius, the coarse particle sintering point is in a range from 1000 to 1300 degrees Celsius, and the nanoparticle sintering point is in a range 1000 to 1400 degrees Celsius.

In a ninth aspect according to the previous aspects, the first layer comprises: from 50 to 70 weight percent coarse particles, and from 30 to 50 weight percent first fine particles.

In a tenth aspect according to the previous aspects, the second layer comprises: from 40 to 75 weight percent second fine particles, and from 25 to 60 weight percent nanoparticles.

In an eleventh aspect according to the previous aspects, there is from 50 to 75 weight percent first layer, and, from 25 to 50 weight percent second layer.

In a twelfth aspect according to the previous aspects, the first fine particles are dendritic, and the second fine particles are dendritic.

In a thirteenth aspect according to the previous aspects, the membrane comprises a tube.

In a fourteenth aspect according to the thirteenth aspect, the tube has a diameter in a range from 0.5 to 2 inches.

In a fifteenth aspect according to the thirteenth or fourteenth aspect, the membrane has a radial crush test value of at least 30 kilopounds per square inch, as tested according to ASTM B939-21.

In a sixteenth aspect according to the previous aspects, the membrane has a bubble point of at least 25 pounds per square inch as measured by ASTM E 128-99 (2019), measured by using 60/40 isopropyl alcohol (IPA)/water.

In a seventeenth aspect, a filter assembly comprises a filter housing that contains a filter membrane of any of the previous aspects.

In an eighteenth method of processing supercritical carbon dioxide, the method comprising passing supercritical carbon dioxide through a membrane of any of the previous aspects.

In a nineteenth method of forming a porous membrane, the method comprises preparing a precursor comprising a first blend of inorganic particles comprising: coarse particles having a particle size of at least 10 microns and a coarse particle sintering point, and first fine particles having a particles size of at least 1 micron and a first fine particle sintering point below the coarse particle sintering point; applying a second blend of inorganic particles to a surface of the precursor, the second blend comprising second fine particles having a particle size of at least 1 micron and a second fine particle sintering point below the coarse particle sintering point, and nanoparticles having a particle size below 1 micron and a nanoparticle sintering point above the first fine particle sintering point and above the second fine particle sintering point.

In a twentieth aspect according to the nineteenth aspect further comprising compressing the first blend of metal particles to form a first green body, applying the second blend of metal particles to the first green body, compressing first green body and second blend of metal particles to form a second green body, and sintering the second green body.

In a twenty-first aspect according to the twentieth aspect, sintering comprises increasing a temperature of the second green body such that: the first fine particles and the second fine metal particles begin sintering before the coarse metal particles begin sintering, and the fine particles begin sintering before the nanoparticles begin sintering.

In a twenty-second aspect according to the twenty-first aspect, the coarse particles begin sintering before the nanoparticles.

In a twenty-third aspect according to any of the nineteenth through twenty-second aspects, the membrane comprises a tube.

In a twenty-fourth aspect according to the twenty-third aspect, the tube has a diameter in a range from 0.5 to 2 inches.

In a twenty-fifth aspect according to the twenty-third or twenty-fourth aspect, the membrane has a radial crush test value of at least 30 kilopounds per square inch, as tested according to ASTM B939-21.

In a twenty-sixth aspect according to the twenty-third, twenty-fourth aspect or twenty-fifth aspect, the membrane has a bubble point of at least 25 pounds per square inch as measured by ASTM E 128-99 (2019), measured by using 60/40 isopropyl alcohol (IPA)/water.

In a twenty-seventh aspect, a tubular porous membrane comprises coarse particles having a particle size of at least 10 microns, fine particles having a particles size of at least 1 micron, and nanoparticles having a particle size below 1 micron, wherein the porous membrane has: a bubble point of at least 30 pounds per square inch as measured by ASTM E 128-99 (2019), measured by using 60/40 isopropyl alcohol (IPA)/water, an air flux value of a least 0.07 slpm/cm2 at 30 psi, and a radial crush test value of at least 35 kilopounds per square inch measured using ASTM B939-21.

In a twenty-eight aspect according to the twenty-seventh aspect the membrane further comprises a first layer comprising a combination of sintered inorganic particles comprising: coarse particles having a particle size of at least 10 microns, and first fine particles having a particles size of at least 1 micron, and a second layer comprising a combination of sintered inorganic particles comprising: second fine particles having a particle size of at least 1 micron, and nanoparticles having a particle size below 1 micron.

In a twenty-ninth aspect according to the twenty-seventh or twenty-eighth aspect, the membrane comprises a tube having a diameter in a range from 0.5 to 2 inches.

1. A porous membrane comprising:
a first layer comprising a combination of sintered inorganic particles comprising:
coarse particles having a particle size of at least 10 microns and a coarse particle sintering point, and
first fine particles having a particles size of at least 1 micron and a first fine particle sintering point below the coarse particle sintering point, and
a second layer comprising a combination of sintered inorganic particles comprising:
second fine particles having a particle size of at least 1 micron and a second fine particle sintering point below the coarse particle sintering point, and
nanoparticles having a particle size below 1 micron and a nanoparticle sintering point above the first fine particle sintering point and above the second fine particle sintering point.

2. The membrane of claim 1, wherein the coarse particles have a particle size in a range from 10 to 200 microns.

3. The membrane of claim 1, wherein:
the first fine particles have a particle size in a range from 1 to 10 microns, and
the second fine particles have a particle size in a range from 1 to 10 microns.

4. The membrane of claim 1, wherein the nanoparticles have a size in a range from 0.001 to 0.5 micron.

5. The membrane of claim 1, wherein,
the first fine particles comprise nickel or a nickel alloy,
the second fine particles comprise nickel or a nickel alloy,
the coarse particles comprise nickel or a nickel alloy, and
the nanoparticles comprise stainless steel.

6. (canceled)

7. The membrane of claim 1, wherein,
the first fine particles comprise stainless steel,
the second fine particles comprise stainless steel,
the coarse particles comprise stainless steel, and
the nanoparticles comprise titanium, titanium alloy, alumina, or zirconia (ZrO₂).

8. (canceled)

9. The membrane of claim 1, wherein the first layer comprises:
from 50 to 70 weight percent coarse particles, and
from 30 to 50 weight percent first fine particles.

10. The membrane of claim 1, wherein the second layer comprises:
from 40 to 75 weight percent second fine particles, and
from 25 to 60 weight percent nanoparticles.

11. The membrane of claim 1, comprising:
from 50 to 75 weight percent first layer, and
from 25 to 50 weight percent second layer.

12. The membrane of claim 1, wherein
the first fine particles are dendritic, and
the second fine particles are dendritic.

13. The membrane of claim 1, wherein the membrane comprises a tube.

14. (canceled)

15. (canceled)

16. The membrane of claim 1, wherein the membrane has a bubble point of at least 25 pounds per square inch as measured by ASTM E 128-99 (2019), measured by using 60/40 isopropyl alcohol (IPA)/water.

17. A filter assembly comprising a filter housing that contains a filter membrane of claim 1.

18. A method of processing supercritical carbon dioxide, the method comprising passing supercritical carbon dioxide through a membrane of claim 1.

19. A method of forming a porous membrane, the method comprising:
preparing a precursor comprising a first blend of inorganic particles comprising:
coarse particles having a particle size of at least 10 microns and a coarse particle sintering point, and
first fine particles having a particles size of at least 1 micron and a first fine particle sintering point below the coarse particle sintering point; and
applying a second blend of inorganic particles to a surface of the precursor, the second blend comprising
second fine particles having a particle size of at least 1 micron and a second fine particle sintering point below the coarse particle sintering point, and
nanoparticles having a particle size below 1 micron and a nanoparticle sintering point above the first fine particle sintering point and above the second fine particle sintering point.

20. The method of claim 19, further comprising:
compressing the first blend of inorganic particles to form a first green body,
applying the second blend of inorganic particles to the first green body,
compressing first green body and second blend of inorganic particles to form a second green body, and
sintering the second green body.

21. The method of claim 20, wherein sintering comprises increasing a temperature of the second green body such that:
the first fine particles and the second fine particles begin sintering before the coarse metal-particles begin sintering, and
the first fine particles and the second fine particles begin sintering before the nanoparticles begin sintering.

22. The method of claim 21, wherein the coarse particles begin sintering before the nanoparticles.

23-25. (canceled)

26. The method of claim 20, the membrane having a bubble point of at least 25 pounds per square inch as measured by ASTM E 128-99 (2019), measured by using 60/40 isopropyl alcohol (IPA)/water.

27. A tubular porous membrane comprising:
coarse particles having a particle size of at least 10 microns,
fine particles having a particles size of at least 1 micron, and
nanoparticles having a particle size below 1 micron,
wherein the porous membrane has:
a bubble point of at least 30 pounds per square inch as measured by ASTM E 128-99 (2019), measured by using 60/40 isopropyl alcohol (IPA)/water,
an air flux value of a least 0.07 slpm/cm2 at 30 psi, and
a radial crush test value of at least 35 kilopounds per square inch measured using ASTM B939-21.

28. (canceled)

29. (canceled)
